(19) United States
(12) Patent Application Publication
(10) Pub. No.: US 2005/0068955 A1
(43) Pub. Date: Mar. 31, 2005

(54) Multicast system, communication terminal, and multicast device

(75) Inventor: Izumi Shimazaki, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION

(21) Appl. No.: 10/948,256

(22) Filed: Sep. 24, 2004

(30) Foreign Application Priority Data
Sep. 26, 2003 (JP) 334999/2003

(51) Int. Cl. H04L 12/56

(52) U.S. Cl. 370/390

(57) ABSTRACT

A multicast system includes a multicast device and a communication terminal such as a mobile phone. The mobile phone has a switch, and voice information can be transmitted only while the switch is on. When the voice information is multicast to a plurality of mobile phones, the mobile phone in question transmits the telephone numbers of the plurality of mobile phones to which the voice information is to be multicast, and a group code which specifies the group of the mobile phones, to the multicast device via a network. The multicast device stores, in a storage unit, the group code and the telephone numbers of the mobile phones included in the group, and at the same time, multicasts the received voice information to these mobile phones.

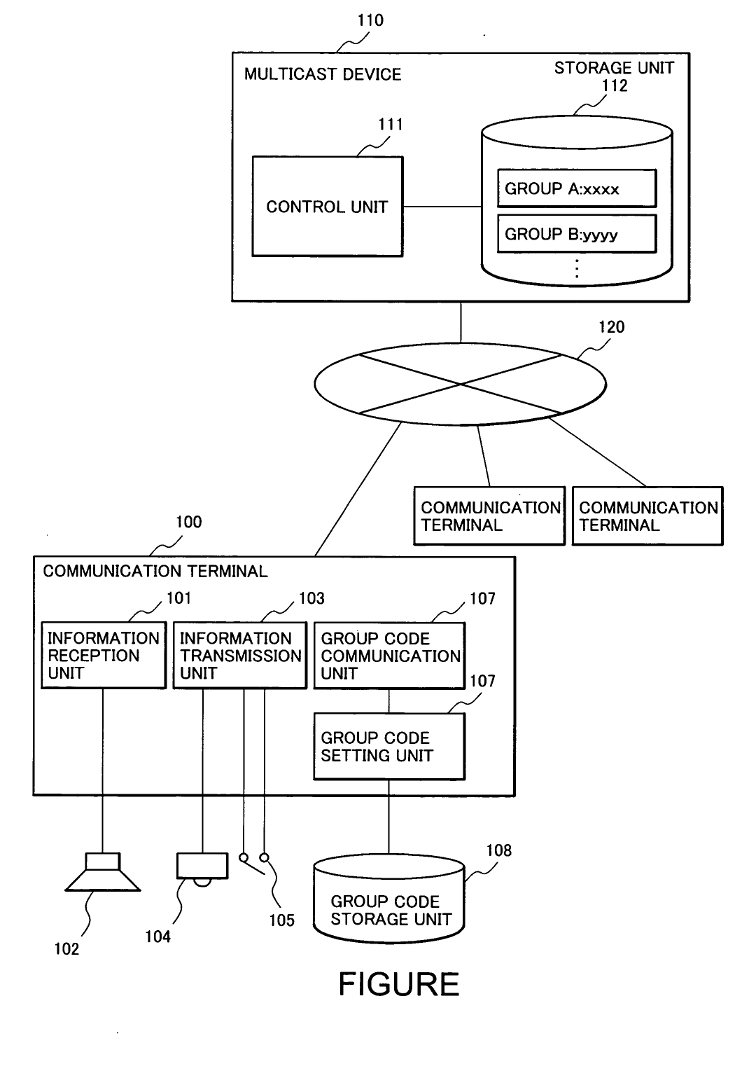

### BACKGROUND OF THE INVENTION

1. Field of the Invention

The present invention relates to a multicast system and, more particularly, to a multicast system in which three or more callers can carry out a conversation in real time using mobile terminals such as mobile phones.

2. Description of the Related Art

Conventionally, to carry out a conversation using communication terminals such as mobile phones, a service is available-such as person-to-person calling or three-way calling utilizing a three-way calling service provided by switching equipment. A caller needs to input the telephone number of a callee into a communication terminal and transmit the telephone number to the switching equipment. Basically, the caller and the callee can talk at the same time.

On the other hand, there are a number of known methods for performing multicast communication, in which a voice is communicated to a plurality of callees by using a communication terminal. A user of the communication terminal can utilize a multicast communication service provided by a network carrier. The user first connects the communication terminal to a multicast device operated by the carrier. Next, the user transmits voice information to be multicast (in other words, simultaneously sent) and the multicast device records this information. The user transmits information about callees to whom the voice information is to be multicast, through key entry into the communication terminal. In accordance with the received information, the multicast device multicasts (in other words, simultaneously sends) the recorded voice information to the designated callees. The Japanese Unexamined Patent Publication No. 2000-134307 discloses a method of sequentially multicasting voice information only by operating a communication terminal such as a mobile phone. A user enters multicast destinations, for each group, into a multicast transmission table in the communication terminal. In multicast transmission, the user records a voice message to be multicast on a voice data storage unit, designates a group name, and inputs a multicast instruction. Then, the communication terminal starts multicast processing. The communication terminal calls one of telephone numbers registered in the designated group, and reproduces and transmits the voice data recorded on the voice data storage unit. After the transmission is completed, clearing processing is executed. The communication terminal executes the similar processing for each of the other telephone numbers registered in the group. When the transmission to all the telephone numbers registered in the same group is completed, the multicast processing is terminated. On the other hand, the Japanese Unexamined Patent Publication No. 2001-309022 discloses a technology by which a calling station connected to a local station via a public network can change a setting about a multicast transmission function of the local station.

However, a voice message cannot be multicast in real time to all the communication terminals of the designated group by the foregoing multicast method. Moreover, in the case of there being a large number of callees to which a massage is to be multicast, information on the large number of multicast callees must be keyed every time a multicast is performed.

### SUMMARY OF THE INVENTION

In a multicast system of the present invention, information is multicast to a plurality of communication terminals via a network. The multicast system includes a communication terminal and a multicast device. The communication terminal transmits information to be multicast to the multicast device. The multicast device receives the information from the communication terminal and multicasts the information to all communication terminals having a group code designated by the communication terminal, except the communication terminal. The multicast device can store the group code and identifications of the communication terminals included in the group.

A communication terminal of the present invention includes an information transmission unit, an information reception unit and a switch enabling information to be transmitted during its on-state. The communication terminal can include a storage unit for storing a group code that specifies a group of a plurality of communication terminals to which information is to be multicast.

A multicast device of the present invention multicasts information to a plurality of communication terminals via a network. The multicast device includes a control unit for controlling multicast operation, and a storage unit for storing a group code, which specifies a group of communication terminals, and for storing the identifications of the communication terminals. When the multicast device receives a group code and information from a communication terminal, the multicast device multicasts the information to all the communication devices, other than the communication device, included in the group.

The above-described multicast system, communication terminal and multicast device enable three or more callers to easily carry out a multicast conversation in real time using the communication terminals.

### BRIEF DESCRIPTION OF THE DRAWINGS

The above and other objects, features and advantages of the present invention will become apparent from the following detailed description when taken with the accompanying drawings in which:

FIGURE shows an embodiment of a multicast system of the present invention.

### DETAILED DESCRIPTION OF THE PREFERRED EMBODIMENTS

Now, the preferred embodiments of the present invention will be described below. FIGURE is a block diagram of an embodiment of a multicast system of the present invention. This multicast system basically includes a communication terminal 100 such as a mobile phone or a home computer, and a multicast device 110. The communication terminal 100 is connected to the multicast device 110 via a network 120. In addition, a large number of communication terminals are similarly connected to the multicast device 110 via the network 120. The communication terminal 100 includes an information reception unit 101 for receiving information (e.g., a voice of a caller or a callee) from the multicast device 110, and an information transmission unit 103 for transmitting information (e.g., a voice of a caller or a callee) to the multicast device 110. A speaker 102 is connected to the information reception unit 101. The information transmission unit 103 is connected to a microphone 104 and a switch 105 which permits the transmission of information only during its on-state. The communication terminal 100 further includes a group code communication unit 106, a group code setting unit 107, and a group code storage unit 108. The operator of the communication terminal 100 sets a group code which specifies a group of predetermined callees (practically, telephone numbers of the callees), by means of the group code setting unit 107. The set group code is stored in the group code storage unit 108. When the operator starts to multicast information such as a voice, the group code communication unit 106 transmits the group code selected by the operator to the multicast device 110. The group code storage unit 108 can store the telephone numbers of communication terminals associated with the group code.

The communication terminal 100 includes a variety of devices (not shown) which are necessary to transmit and receive information. Moreover, the communication terminal 100 can multicast still pictures and moving pictures, in addition to voice information, if the terminal 100 has a camera function. The communication terminal 100 can include a storage unit for storing the static images and moving images. When the communication terminal 100 is a mobile phone, information to be multicast is transmitted to the multicast device 110 via a wireless base station and the network 120. For the communication terminal 100, a publicly-known IP telephone is applicable.

The multicast device 110, connected to the network 120, includes a control unit 111 and a storage unit 112. The control unit 111 receives a group code from the communication terminal 100 and multicasts information to communication terminals of a group having the group code. The storage unit 112 stores the group code transmitted from the communication terminal and identifications (one or more than one of numbers, letters and marks, i.e., telephone numbers, IP addresses, or the like) of the communication terminals to which the information is to be multicast. The unit 112 further stores information on the association between the identifications and the group code. When transmitting information, the communication terminal 100 can transmit the identifications of the communication terminals to which the information is to be multicast, in addition to the group code. However, the control unit 111 can receive and store a group code and the identifications of the communication terminals belonging to the group from the communication terminal 100 in advance. Moreover, the control unit 111 can set a group code on a group of telephone numbers received from a communication terminal, store the group code, and notify the communication terminal of the set group code.

The networks 120 include, for example, a normal public telephone network, a TCP/IP network such as the Internet, and the like. A router and the like can be connected to the network 120.

Now, an exemplary operation of the multicast system of the present invention will be described below. Using a built-in browser, the communication terminal 100 establishes a connection with a Web server annexed to the multicast device 110. When the communication terminal 100 is connected to the multicast device 110, a menu screen for the entry of a group code appears on a display portion of the communication terminal 100. An operator inputs a group code and transmits the group code and the telephone numbers of communication terminals associated with the group code via a network. At this time, if the telephone numbers have been already stored in the storage unit of the communication terminal, it is not necessary for the operator to input the telephone numbers again. If the multicast device has already stored group codes and associated telephone numbers, any of the group codes including the communication terminal 100 performing multicast can be displayed on the display portion. In this case, the operator selects a desired group code. The multicast device 110 stores the group code selected in the storage unit. If the telephone numbers are transmitted from the communication terminal 100, the multicast device 110 also stores the telephone numbers, associating the telephone numbers with the group code. Next, the operator of the communication terminal 100 turns on the switch 105 and thereby starts to transmit information (that is, voice). When the operator finishes transmitting the voice, the operator turns off the switch 105. That is, the voice information is transmitted to the multicast device 110 only while the switch 105 is on. Based on the group code transmitted from the communication terminal 100, the control unit 111 of the multicast device 110 multicasts the voice to communication terminals belonging to the group. The control unit 111 can reject receiving information from another communication terminal while the information is being received from the communication terminal and/or while the information is being multicast. That is, in the multicast system of the present invention, the number of callers who transmit information is always one. The communication terminal 100 can be set such that while receiving information, the communication terminal 100 cannot transmit information even if the switch 105 is turned on. When the information transmission from the communication terminal has been finished, a communication terminal which first turns on the switch 105 thereafter can preferentially execute information transmission.

When the communication terminals are mobile phones, the control unit 111 can exclude a mobile phone positioned in a no service area or a mobile phone turned off, from multicast targets. The control unit 111 can provide notification of data concerning a communication terminal excluded from the multicast targets or a communication terminal which has not received the information, to the communication terminal which has started multicasting or all the communication terminals belonging to the same group. This provided data can be displayed on the display portion of the communication terminal.

According to the present invention, three or more callers can easily multicast information such as voices in real time.

While the present invention has been described in connection with certain preferred embodiments, it is to be understood that the subject matter encompassed by the present invention is not limited to those specific embodiments. On the contrary, it is intended to include all alternatives, modifications, and equivalents as can be included within the spirit and scope of the following claims.

1. A multicast system in which information is multicast to a plurality of communication terminals via a network, comprising:
a communication terminal; and
a multicast device,
wherein the communication terminal transmits information to be multicast to the multicast device, and
upon receiving the information from the communication terminal, the multicast device multicasts the information to all communication terminals having a group code designated by the communication terminal, except the communication terminal.

2. The multicast system according to claim 1,
wherein the communication terminal transmits to the multicast device identification of the communication terminals to which the information is to be multicast, and
the multicast device stores the identification.

3. The multicast system according to claim 2,
wherein the communication terminal transmits to the multicast device the identification of the communication terminals to which the information is to be multicast, together with the group code.

4. The multicast system according to claim 2,
wherein the multicast device gives a single group code to the identification transmitted from the communication terminal, and notifies the communication terminal of the group code.

5. The multicast system according to claim 1,
wherein the communication terminal that starts multicasting transmits the information to the multicast device during a predetermined period when transmission is permitted.

6. The multicast system according to claim 5,
wherein the period when transmission is permitted is a period when a switch included in the communication terminal is in an on-state.

7. The multicast system according to claim 6,
wherein an operator of the communication terminal that transmits the information operates the switch.

8. The multicast system according to claim 1,
wherein the communication terminal that starts multicasting accesses the multicast device and selects a desired group code from among group codes of a plurality of groups, each including the identification of the communication terminal.

9. The multicast system according to claim 1,
wherein the information is at least one of a sound, a still picture and a moving picture.

10. The multicast system according to claim 1,
wherein the communication terminal is a mobile phone.

11. The multicast system according to claim 1,
wherein while the multicast device is multicasting the information to the communication terminals, the multicast device rejects receiving information transmitted from the communication terminal.

12. The multicast system according to claim 1,
wherein after the multicast device has finished transmitting the information, information first transmitted from a communication terminal thereafter is multicast from the multicast device to the other communication terminals of the same group.

13. The multicast system according to claim 1,
wherein the multicast device provides notification of data concerning a communication terminal which belongs to a group specified by the group code and does not receive the information, to at least one of the other communication terminals of the group.

14. The multicast system according to claim 1,
wherein the multicast system operates in an IP phone system.

15. A communication terminal used in a multicast system, comprising:
an information transmission unit;
an information reception unit; and
a switch enabling information to be transmitted during an on-state thereof.

16. The communication terminal according to claim 15, further comprising:
a storage unit for storing a group code that specifies a group of a plurality of communication terminals to which information is to be multicast.

17. The communication terminal according to claim 15, further comprising:
a storage unit for storing identification of a plurality of communication terminals to which information is to be multicast.

18. The communication terminal according to claim 15,
wherein the communication terminal is a mobile phone.

19. The communication terminal according to claim 15,
wherein the information is at least one of a sound, a still picture and a moving picture.

20. The communication terminal according to claim 15,
wherein the communication terminal is disabled from transmitting the information while the communication terminal is receiving information.

21. A multicast device that multicasts information to a plurality of communication terminals via a network, comprising:
a control unit for controlling multicast operation; and
a storage unit for storing a group code that specifies a group of communication terminals, and identification of the communication terminals,
wherein upon receiving information from a communication terminal, the multicast device multicasts the information to all communication terminals, other than the communication terminal, included in a group specified by a group code designated by the communication terminal.

22. The multicast device according to claim 21,
wherein while the information is being multicast to the plurality of communication terminals, the control unit rejects receiving the information transmitted from the communication terminal.

23. The multicast device according to claim 21,
wherein the control unit provides notification of data concerning a communication terminal that belongs to the group and does not receive the information, to at least one of the other communication terminals of the same group.
